(19) United States
(12) Patent Application Publication
(10) Pub. No.: US 2011/0080442 A1
(43) Pub. Date: Apr. 7, 2011

(54) SYSTEM FOR COLOR SHIFT COMPENSATION IN AN OLED DISPLAY USING A LOOK-UP TABLE, A METHOD AND A COMPUTER-READABLE MEDIUM

(75) Inventors: Amalkumar P. Ghosh, Beacon, NY (US); Ihor Wacyk, Hopewell Junction, NY (US); Tariq Ali, Hopewell Junction, NY (US); Ilyas Khayrullin, Flanders, NY (US)

(73) Assignee: EMAGIN CORPORATION, Hopewell Junction, NY (US)

(21) Appl. No.: 12/897,449

(22) Filed: Oct. 4, 2010

Related U.S. Application Data
(60) Provisional application No. 61/278,299, filed on Oct. 5, 2009.

(51) Int. Cl. G09G 3/32; G09G 5/02

(52) U.S. Cl. 345/694; 345/76

(57) ABSTRACT

A light emitting system is provided that includes an OLED pixel including at least two OLED sub-pixels having different associated color outputs, and at least one digitally accessible look-up table including energizing signal values for the at least two sub-pixels as a function of a desired color and a desired luminance intensity of the OLED pixel when energized. The light emitting system also includes a drive circuit adapted to access the at least one look-up table and able to independently energize the at least two OLED sub-pixels based on the energizing signal values obtained from the at least one look-up table. A method is provided for energizing an organic light emitting diode (OLED) pixel. A computer-readable medium is provided that stores a digitally accessible look-up table accessible by a drive circuit and for operating an organic light emitting diode (OLED) pixel.

### CROSS-REFERENCE TO RELATED APPLICATIONS

This application claims the benefit of U.S. Provisional Application No. 61/278,299 filed Oct. 5, 2009, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to organic light emitting diodes (OLEDs). In particular, the present invention relates to a system for color shift compensation in an OLED display using a look-up table, a method of using a look-up table to compensate for color variation with luminance, and a computer-readable medium holding a look-up table.

2. Description of Prior Art

An OLED device typically includes a stack of thin layers formed on a substrate. A light-emitting layer of a luminescent organic solid, as well as adjacent semiconductor layers, are sandwiched between a cathode and an anode. The light-emitting layer may be selected from any of a multitude of fluorescent and phosphorescent organic solids. Any of the layers, and particularly the light-emitting layer, also referred to herein as the emissive layer or the organic emissive layer, may consist of multiple sublayers.

In a typical OLED display, either the cathode or the anode is transparent or semitransparent. The films may be formed by evaporation, spin casting, chemical self-assembly or any other appropriate polymer film-forming techniques. Thicknesses typically range from a few monolayers (i.e., a single, closely packed layer of atoms or molecules, perhaps as thin as one molecule), up to about 1000 to 2,000 angstroms.

Protection of an OLED display against oxygen and moisture can be achieved by encapsulation of the device. The encapsulation can be obtained by means of a single thin-film layer surrounding the OLED situated on the substrate.

High resolution active matrix displays may include millions of pixels and sub-pixels that are individually addressed by the drive electronics. The drive electronics for each sub-pixel can have several semiconductor transistors and other integrated circuit (IC) components. Each OLED may correspond to a pixel or a sub-pixel, and therefore these terms are used interchangeably hereinafter.

In an OLED device, one or more layers of semiconducting organic material are sandwiched between two electrodes. An electric current is applied across the device, causing negatively charged electrons to move into the organic material(s) from the cathode. Positive charges, typically referred to as holes, move in from the anode. The positive and negative charges meet in the center layers (i.e., the semiconducting organic material), combine, and produce photons. The wave-length—and consequently the color—of the photons depends on the electronic properties of the organic material in which the photons are generated.

The color of light emitted from the organic light emitting device can be controlled by the selection of the material used to form the emissive layer. White light may be produced by generating blue, red and green lights simultaneously. Other individual colors, different than red, green and blue, can be also used to produce in combination a white spectrum. The precise color of light emitted by a particular structure can be controlled both by selection of the organic material, as well as by selection of dopants in the organic emissive layers. Alternatively or additionally, filters of red, green or blue (or other colors), may be added on top of a white light emitting pixel. In further alternatives, white light emitting OLED pixels may be used in monochromatic displays.

Pixel drivers can be configured as either current sources or voltage sources to control the amount of light generated by the OLEDs in an active matrix display.

The color of light emitted from an OLED sub-pixel may vary with luminance (e.g., current), and may also vary with a temperature of the emissive layer. The International Commission on Illumination (CIE) provides color charts that identify each color based on an x and y coordinate, which may be called the CIE x and the CIE y.

### BRIEF SUMMARY OF THE INVENTION

An exemplary embodiment of the present innovation compensates for color shift with current density in phosphorescent devices. A plot of the CIE coordinate variation with an energizing value (for example, a current density) is stored in a look-up table (also referred to as a “Look Up” table or an LUT). This look-up table may be stored either on the chip or on the board. The look-up table will adjust the strengths of the blue, green and red channel signals to maintain a fixed ratio of the luminance of the primary colors to maintain a fixed color balance. As the gray level is changed to the desired value, the look-up table adjusts the strength of the individual color channels according to a stored model of the OLED CIE dependence on current density. In some exemplary embodiments, a separate look-up table is required for each color channel which can have a uniquely defined value. Alternatively, each entry in the table may have energizing values for the different OLED sub-pixels corresponding to the different primary colors. Additionally, these look-up tables can be updated, or different tables can be accessed, according to the operating current density of the OLED pixels using a temperature model or based on an operating temperature.

A light emitting system is provided that includes an OLED pixel including at least two OLED sub-pixels having different associated color outputs, and at least one digitally accessible look-up table including energizing signal values for the at least two sub-pixels as a function of a desired color and a desired luminance intensity of the OLED pixel when energized. The light emitting system also includes a drive circuit adapted to access the at least one look-up table and able to independently energize the at least two OLED sub-pixels based on the energizing signal values obtained from the at least one look-up table.

In the light emitting system, the desired color includes a CIE x value and a CIE y value, and the at least one look-up table includes a CIE x dimension, a CIE y dimension and a luminance dimension. Each entry in the at least one look-up table may include the energizing signal values for each of the at least two sub-pixels.

The at least two OLED sub-pixels may be three OLED sub-pixels, specifically a red OLED sub-pixel, a green OLED sub-pixel and a blue OLED sub-pixel. The look-up table may compensate for color variation in the red OLED sub-pixel, the green OLED sub-pixel and the blue OLED sub-pixel by adjusting the energizing signal values to maintain a fixed ratio of a luminance of primary colors when the desired luminance intensity changes.

The light emitting system may include a temperature model providing an estimated temperature for the OLED pixel based on the energizing signal values from an immediately prior time period. The light emitting system may alternatively include a temperatures sensor adapted to provide a temperature reading of the OLED pixel. The at least one look-up table may include a temperature dimension, and the drive circuit may be further adapted to access the at least one look-up table based on the estimated temperature or the temperature reading. Alternatively, the at least one look-up table may include a plurality of look-up tables, each look-up table having a corresponding temperature range, and the drive circuit may be further adapted to access the at least one look-up table having the corresponding temperature range that includes the estimated temperature or the temperature reading.

The energizing signal values may include current densities for the at least two sub-pixels, and the drive circuit may energize the at least two OLED sub-pixels based on the current densities and known areas for the at least two OLED sub-pixels.

The look-up table may be stored in a chip on which the OLED pixel is situated or a board including a drive circuit for an array including the OLED pixel.

A method is provided for energizing an organic light emitting diode (OLED) pixel that includes at least two OLED sub-pixels having different associated color outputs. The method includes receiving a signal defining a desired color and a desired luminance intensity of the OLED pixel, and retrieving from at least one digitally accessible look-up table a respective energizing signal value for each of the OLED sub-pixels based on the desired color and the desired luminance intensity of the OLED pixel. The method also includes providing the respective energizing signal values to each of the OLED sub-pixels.

A computer-readable medium is provided that stores a digitally accessible look-up table accessible by a drive circuit and for operating an organic light emitting diode (OLED) pixel including a red OLED sub-pixel, a green OLED sub-pixel and a blue OLED sub-pixel. The look-up table includes a CIE x dimension, a CIE y dimension orthogonal to the CIE x dimension, and a luminance dimension orthogonal to the CIE x dimension and the CIE y dimension. The look-up table also includes a red OLED sub-pixel energizing signal value, a green OLED sub-pixel energizing signal value and a blue OLED sub-pixel energizing signal value at each point in the look-up table defined by the CIE x dimension, the CIE y dimension, and the luminance dimension.

The look-up table may further include a temperature dimension orthogonal to the CIE x dimension, the CIE y dimension and the luminance dimension. The drive circuit may be further adapted to access the at least one look-up table based on an estimated temperature or a temperature reading. The computer-readable medium may store at least one other look-up table, and each look-up table may have a corresponding temperature range and the drive circuit may be further adapted to access the at least one look-up table having the corresponding temperature range that includes the estimated temperature or the temperature reading.

### BRIEF DESCRIPTION OF THE DRAWINGS

FIG. 1 is a schematic diagram of an OLED pixel drive system in accordance with an exemplary embodiment;

FIG. 2a is a graph illustrating luminance as a function of current density superimposed on a graph illustrating CIE variation (x or y) as a function of current density for a phosphorescent white OLED;

FIG. 2b is a graph illustrating luminance as a function of current density superimposed on a graph illustrating CIE variation (x or y) as a function of current density for a phosphorescent white OLED and white OLEDs with color filters;

FIG. 3 is a schematic view of an OLED pixel including an OLED controller and a pixel in accordance with an exemplary embodiment;

FIG. 4 illustrates a method according to an exemplary embodiment;

FIG. 5 illustrates a computer system according to an exemplary embodiment; and

FIG. 6 illustrates an exemplary look-up table geometry including CIE x, CIE y, and luminance coordinates according to an exemplary embodiment.

### DETAILED DESCRIPTION OF THE INVENTION

Phosphorescent based white OLED devices may exhibit CIE coordinate variation depending on the applied current due to the movement of the electron hole recombination zone in the emission layer of the device. This variation of the CIE coordinates may pose a problem in the realization of practical OLED displays with predictable color output, since the color changes with gray level (i.e., the luminance intensity).

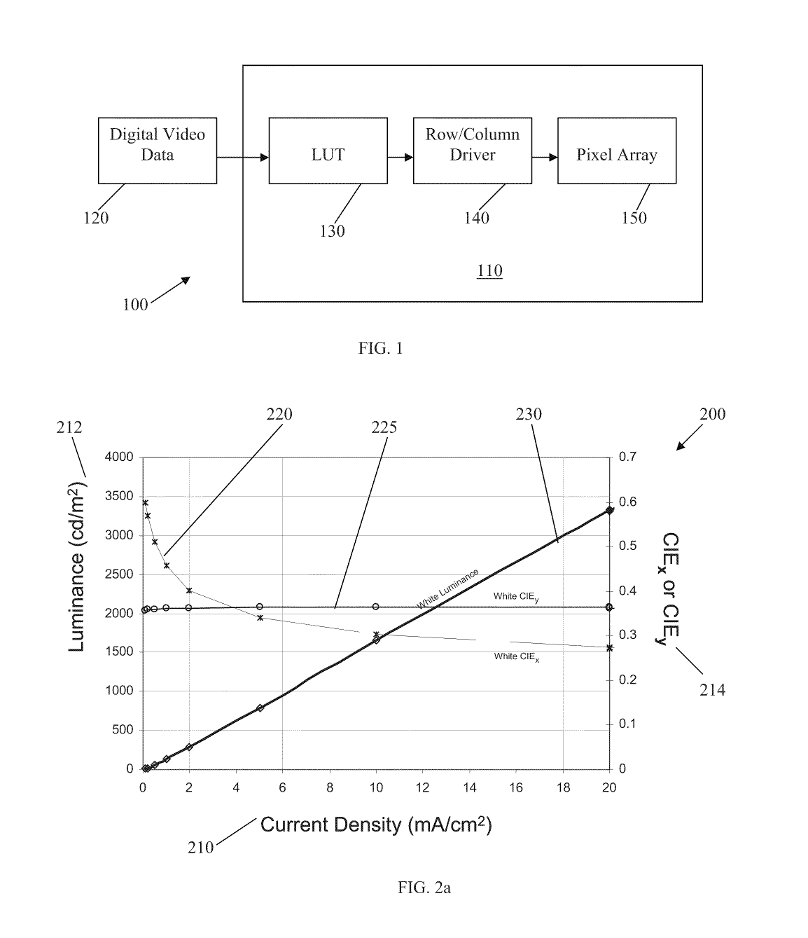

FIG. 1 is a schematic diagram of OLED pixel drive system 100 in accordance with an exemplary embodiment. OLED pixel drive system 100 includes OLED pixel controller 110 which receives digital video data 120. OLED pixel controller 110 accesses LUT (look-up table) 130 which is stored internally. Alternatively, LUT 130 may be stored remotely. OLED pixel controller 110 may also receive temperature data or may include a temperature model, and may update LUT 130 based on an estimated temperature or a temperature reading, or may access an LUT 130 that is valid for a particular temperature, while storing other LUTs that are valid for other temperature ranges. LUT 130 may be for a particular sub-pixel having a particular color coordinate, in which case other LUTs would be accessed by OLED pixel controller 110 to the other OLED sub-pixels within the OLED pixel. In another alternative exemplary embodiment, LUT 130 may be three-dimensional table with axes for a CIE x, a CIE y, and a luminance, and may include three values for each entry in the table. The three values representing energizing values for three OLED sub-pixels in which each of the OLED sub-pixels represents a primary color. In this manner, the LUT may compensate for variation in the output of different OLED sub-pixels. The different OLED sub-pixels may have different emissive layers causing different color outputs, may have different color filters over a white OLED sub-pixel, or may have color filters modifying OLED sub-pixels having particular color outputs. OLED pixel controller 110 may access LUT 130 and provide the energizing signal(s) to row/column driver 140. The energizing signal values may be voltages or currents. Row/column driver 140 may be a drive circuit for a row, column or any other appropriate portion of the pixels or sub-pixels. Row/column driver 140 may apply energizing signals equal to or proportional to the energizing signal value obtained from LUT 130 to a particular pixel, sub-pixel or group of pixels or sub-pixels of pixel array 150. In this manner, color variation of pixels or sub-pixels in pixel array 150 based on different current densities and/or temperatures may be compensated for and the color output of the array may be independent of luminance and/or temperature.

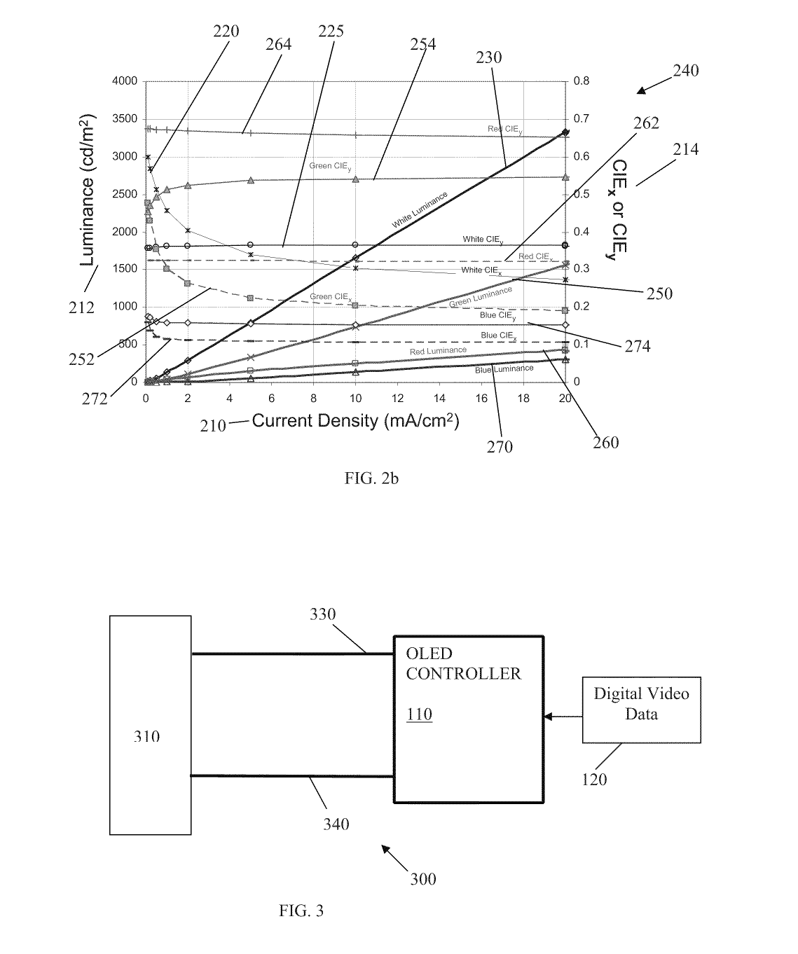

FIG. 2a is graph 200 illustrating luminance as a function of current density superimposed on a graph illustrating CIE variation (x or y) as a function of current density for a phosphorescent white OLED. Graph 200 has x-axis 210 that plots a current density for the OLED. The current density plotted on x-axis 210 is in units of milliamps per centimeter squared, though alternative units may also be possible. The area in a current density measurement is the cross-sectional area of the OLED through which the current passes, i.e., a plane passing through the emissive layer and parallel to the anode and cathode, or a plane perpendicular to a line connecting the anode and cathode. Left y-axis 212 plots luminance of the OLED in units of candela per meter squared, and right y-axis 214 plots both a CIE x and a CIE y in a range from zero to 0.7. Alternative ranges for either the CIE x or the CIE y, or both, on right y-axis 214 are also possible depending on the range of possible outputs of the OLED pixel being graphed, and/or the CIE chart or the equivalent color chart being used. Luminance line 230 is associated with left y-axis 212 and illustrates a linear relationship between current density and luminance in a white OLED.

White CIE x line 220 is associated with right y-axis 214 and illustrates the relationship between current density and the x coordinate of the CIE chart (see FIG. 6 and accompanying description). As is apparent from white CIE x line 220, as the current density is changed, for instance when increasing the luminance of the white OLED, the y coordinate of the CIE chart is not constant, indicating that the color of light emitted by the OLED shifts when the luminance is changed.

White CIE y line 225 is associated with right y-axis 214 and illustrates the relationship between current density and the y coordinate of the CIE chart (see FIG. 6 and accompanying description). As is apparent from white CIE y line 225, as the current density is changed, for instance when increasing the luminance of the white OLED, the y coordinate of the CIE chart may be largely constant, indicating that any change in the color of light emitted by the OLED when the luminance is changed does not occur in the y-axis of the CIE chart.

FIG. 2b is graph 240 illustrating luminance as a function of current density superimposed on a graph illustrating CIE variation (x or y) as a function of current density for a phosphorescent white OLED and white OLEDs with band pass color filters. Alternatively, rather than colored filters arranged on a surface of a white OLED, color outputs may be obtained by appropriate doping or other compositional variation in the emissive layer of the OLED. Graph 240 has the same x and y axes as graph 200, namely x-axis 210 plotting a current density for the OLED, left y-axis 212 plotting luminance of the OLED, and right y-axis 214 plotting both a CIE x and a CIE y. Luminance line 230, white CIE x line 220, and white CIE y line 225 are also shown on graph 240 and are the same as shown in graph 200.

Green luminance line 250, red luminance line 260 and blue luminance line 270 are each associated with left y-axis 212 and each illustrate a linear relationship between current density and luminance in the respective output of an OLED having the associated color. However, each of the luminance lines for the color outputs have lower slopes than for luminance line 230, reflecting the fact that the color filters operate by reducing or eliminating color in wavelengths that are not desired, and therefore reduce the overall luminance of the OLED having a color filter.

Green CIE y line 254, red CIE y line 264 and blue CIE y line 274 are each associated with right y-axis 214 and illustrates the relationship between current density and the y coordinate of the CIE chart (see FIG. 6 and accompanying description) in the respective output of an OLED having the associated color. As is apparent from green CIE y line 254, red CIE y line 264 and blue CIE y line 274, as the current density is changed, for instance when increasing the luminance of the OLED having the respective color filter, the y coordinate of the CIE chart may vary somewhat, particularly at low values, indicating that the color of light emitted by the OLED shifts when the luminance is changed.

Green CIE x line 252, red CIE x line 262 and blue CIE x line 272 are each associated with right y-axis 214 and illustrates the relationship between current density and the x coordinate of the CIE chart (see FIG. 6 and accompanying description) in the respective output of an OLED having the associated color. As is apparent from green CIE x line 252, red CIE x line 262 and blue CIE x line 272, as the current density is changed, for instance when increasing the luminance of the OLED having the respective color filter, the x coordinate of the CIE chart may vary significantly, indicating that the color of light emitted by the OLED shifts when the luminance is changed, perhaps in significant ways.

FIG. 3 is a schematic view of OLED pixel (or sub-pixel) system 300 including OLED controller 110 and pixel 310 in accordance with an exemplary embodiment. OLED controller 110 receives digital video data 120 and processes the data to provide a signal to pixel 310 according to the discussion above. OLED controller 110 processes digital video data 120 into an analog signal that drives pixel 310, and in particular may access a look-up table to compensate for variation in color outputs as luminance varies. The analog signal may be a voltage or a current. Line 330 from OLED controller 110 may couple to an anode of pixel 310 and line 340 from OLED controller 110 may couple to a cathode of pixel 310. Alternatively, line 330 from OLED controller 110 may couple to a cathode of pixel 310 and line 340 from OLED controller 110 may couple to an anode of pixel 310. Pixel 310 may be a white OLED pixel or sub-pixel, with or without a color filter. Alternatively, pixel 310 may have an emissive layer that emits colored light when energized. Pixel 310 may be a sub-pixel paired with one or more other sub-pixels to form a pixel. Each of the sub-pixels may have a corresponding primary color output, for instance red, green and blue, which may be due to the emissive layer properties of the particular sub-pixel, a filter layer arranged on a surface of the sub-pixel, or both. OLED controller 110 may control three sub-pixels, each having an associated primary color either by virtue of the composition of the emissive layer or due to a color filter, and may compensate for variation in the output of each sub-pixel to cause the combined output of the three sub-pixels to correspond to digital video data 120. OLED controller 110 may be a processor or a computer, and may store the look-up table internally or remotely. The look-up table may be stored either on a chip on which the OLED pixel is situated, or on a board including a drive circuit for an array including the OLED pixel.

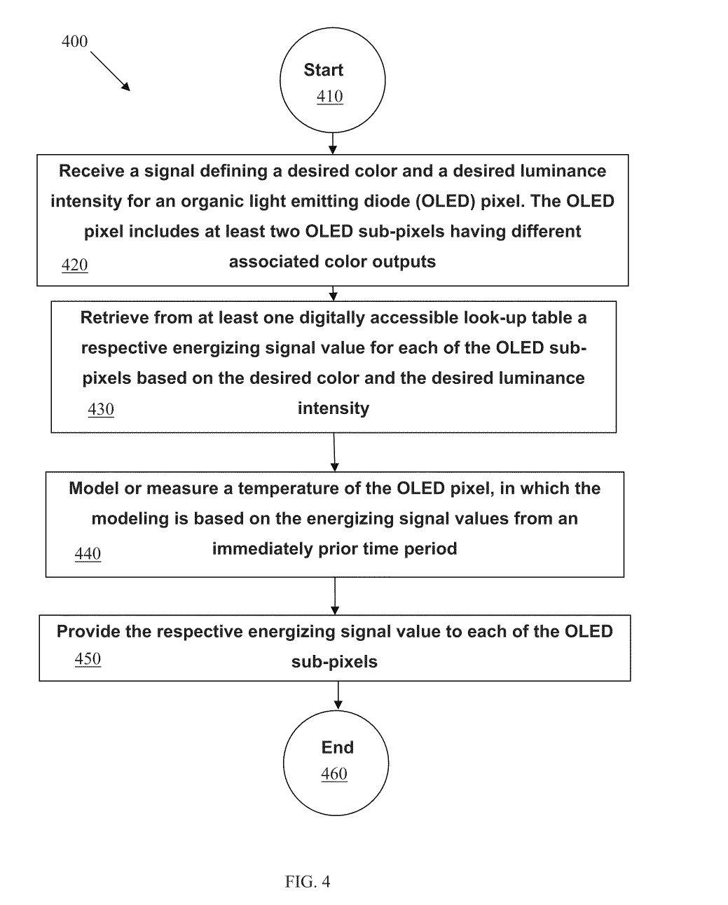

FIG. 4 illustrates method 400 according to an exemplary embodiment. Method 400 starts at start circle 410 and proceeds to operation 420, which indicates to receive a signal defining a desired color and a desired luminance intensity for an organic light emitting diode (OLED) pixel. The OLED pixel includes at least two OLED sub-pixels having different associated color outputs. From operation 420 the flow in method 400 proceeds to operation 430, which indicates to retrieve from at least one digitally accessible look-up table a respective energizing signal value for each of the OLED sub-pixels based on the desired color and the desired luminance intensity. From operation 430 the flow in method 400 proceeds to operation 440, which indicates to model or measure a temperature of the OLED pixel, in which the modeling is based on the energizing signal values from an immediately prior time period. From operation 440 the flow in method 400 proceeds to operation 450, which indicates provide the respective energizing signal value to each of the OLED sub-pixels. From operation 450 the flow in method 400 proceeds to end circle 460.

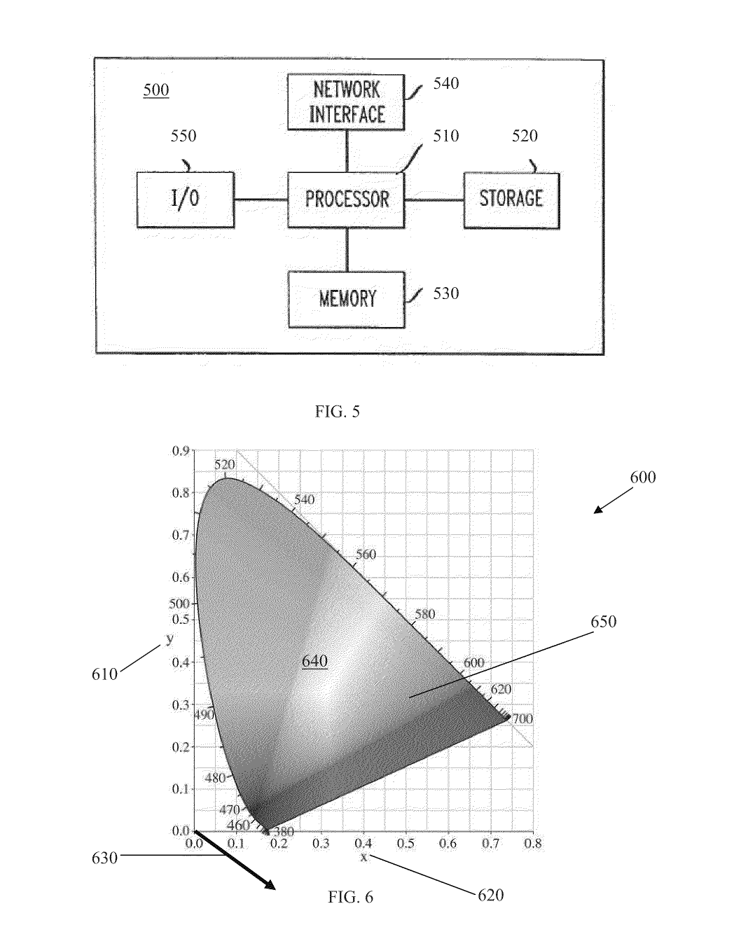

FIG. 5 illustrates a computer system according to an exemplary embodiment. Computer 500 can, for example, operate OLED pixel array system 100, may provide digital video data 120, or may be OLED controller 110. Additionally, computer 500 can perform the steps described above (e.g., with respect to FIG. 4). Computer 500 contains processor 510 which controls the operation of computer 500 by executing computer program instructions which define such operation, and which may be stored on a computer-readable recording medium. The computer program instructions may be stored in storage 520 (e.g., a magnetic disk, a database) and loaded into memory 530 when execution of the computer program instructions is desired. Thus, the computer operation will be defined by computer program instructions stored in memory 530 and/or storage 520 and computer 500 will be controlled by processor 510 executing the computer program instructions. Computer 500 also includes one or more network interfaces 540 for communicating with other devices, for example other computers, servers, or websites. Network interface 540 may, for example, be a local network, a wireless network, an intranet, or the Internet. Computer 500 also includes input/output 550, which represents devices which allow for user interaction with the computer 500 (e.g., display, keyboard, mouse, speakers, buttons, webcams, etc.). One skilled in the art will recognize that an implementation of an actual computer will contain other components as well, and that FIG. 5 is a high level representation of some of the components of such a computer for illustrative purposes.

FIG. 6 illustrates exemplary look-up table 600 having CIE chart 650 superimposed thereon. Look-up table 600 includes CIE x axis 620, CIE y axis 610, and luminance axis 630. Each axis is orthogonal to the other two axes. CIE x axis 620 and CIE y axis 610 together form conventional CIE color chart 640, which typically is shown in color illustrating the particular color associated with a particular x and y coordinate. A particular entry 650 in look-up table 600 is identified by x and y coordinates, thereby identifying the particular color, which may be a desired color (or in other cases a perceived color). Entry 650 is further identified by luminance, which being the third axis is shown projecting out of the page illustrating FIG. 6. In this manner, the three coordinates identify entry 650. Entry 650 may include three values, for instance energizing values for a red, green and blue OLED pixel. Additionally, look-up table 600 may be valid for only a particular range of temperatures, which may be determined by modeling or measuring. Alternatively, look-up table 600 may be a four-dimensional table having a fourth axis plotting temperature.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A light emitting system comprising:
an OLED pixel comprising at least two OLED sub-pixels having different associated color outputs;
at least one digitally accessible look-up table comprising energizing signal values for the at least two sub-pixels as a function of a desired color and a desired luminance intensity of the OLED pixel when energized; and
a drive circuit adapted to access the at least one look-up table and able to independently energize the at least two OLED sub-pixels based on the energizing signal values obtained from the at least one look-up table.

2. The light emitting system of claim 1, wherein:
the desired color comprises a CIE x value and a CIE y value;
the at least one look-up table includes a CIE x dimension, a CIE y dimension and a luminance dimension; and
each entry in the at least one look-up table comprises the energizing signal values for each of the at least two sub-pixels.

3. The light emitting system of claim 1, wherein the at least two OLED sub-pixels are three OLED sub-pixels, the three OLED sub-pixels being a red OLED sub-pixel, a green OLED sub-pixel and a blue OLED sub-pixel.

4. The light emitting system of claim 3, wherein the look-up table compensates for color variation in the red OLED sub-pixel, the green OLED sub-pixel and the blue OLED sub-pixel by adjusting the energizing signal values to maintain a fixed ratio of a luminance of primary colors when the desired luminance intensity changes.

5. The light emitting system of claim 1, further comprising at least one of:
a temperature model providing an estimated temperature for the OLED pixel based on the energizing signal values from an immediately prior time period; and
a temperatures sensor adapted to provide a temperature reading of the OLED pixel.

6. The light emitting system of claim 5, wherein:
the at least one look-up table comprises a temperature dimension; and
the drive circuit is further adapted to access the at least one look-up table based on one of the estimated temperature and the temperature reading.

7. The light emitting system of claim 5, wherein:
the at least one look-up table comprises a plurality of look-up tables, each look-up table having a corresponding temperature range; and
the drive circuit is further adapted to access the at least one look-up table having the corresponding temperature range that includes one of the estimated temperature and the temperature reading.

8. The light emitting system of claim 1, wherein:
the energizing signal values comprise current densities for the at least two sub-pixels; and
the drive circuit energizes the at least two OLED sub-pixels based on the current densities and known areas for the at least two OLED sub-pixels.

9. The light emitting system of claim 1, wherein the look-up table is stored in one of a chip on which the OLED pixel is situated and a board including a drive circuit for an array including the OLED pixel.

10. A method for energizing an organic light emitting diode (OLED) pixel comprising at least two OLED sub-pixels having different associated color outputs, the method comprising:
receiving a signal defining a desired color and a desired luminance intensity of the OLED pixel;
retrieving from at least one digitally accessible look-up table a respective energizing signal value for each of the OLED sub-pixels based on the desired color and the desired luminance intensity of the OLED pixel; and
providing the respective energizing signal values to each of the OLED sub-pixels.

11. The method of claim 10, wherein:
the desired color comprises a CIE x value and a CIE y value;
the at least one look-up table includes a CIE x dimension, a CIE y dimension and a luminance dimension; and
each entry in the at least one look-up table comprises the respective energizing signal values for each of the at least two sub-pixels.

12. The method of claim 10, wherein the at least two OLED sub-pixels are three OLED sub-pixels, the three OLED sub-pixels being a red OLED sub-pixel, a green OLED sub-pixel and a blue OLED sub-pixel.

13. The method of claim 12, wherein the look-up table compensates for color variation in the red OLED sub-pixel, the green OLED sub-pixel and the blue OLED sub-pixel by adjusting the energizing signal values to maintain a fixed ratio of a luminance of primary colors when the desired luminance intensity changes.

14. The method of claim 10, further comprising at least one of:
modeling the OLED pixel based on the energizing signal values from an immediately prior time period to provide an estimated temperature; and
measuring a temperature of the OLED pixel.

15. The method of claim 14, wherein the at least one look-up table comprises a temperature dimension, and further comprising accessing the at least one look-up table based on one of the estimated temperature and the temperature.

16. The method of claim 14, wherein the at least one look-up table comprises a plurality of look-up tables, each look-up table having a corresponding temperature range, and further comprising accessing the at least one look-up table having the corresponding temperature range that includes one of the estimated temperature and the temperature.

17. The method of claim 10, wherein the energizing signal values comprise current densities for the at least two OLED sub-pixels, and further comprising energizing the at least two OLED sub-pixels based on the current densities and known areas for the at least two OLED sub-pixels.

18. The method of claim 10, further comprising storing the look-up table in one of a chip on which the OLED pixel is situated and a board including a drive circuit for an array including the OLED pixel.

19. A computer-readable medium having stored therein a digitally accessible look-up table accessible by a drive circuit and for operating an organic light emitting diode (OLED) pixel comprising a red OLED sub-pixel, a green OLED sub-pixel and a blue OLED sub-pixel, the look-up table comprising:
a CIE x dimension;
a CIE y dimension orthogonal to the CIE x dimension;
a luminance dimension orthogonal to the CIE x dimension and the CIE y dimension; and
a red OLED sub-pixel energizing signal value, a green OLED sub-pixel energizing signal value and a blue OLED sub-pixel energizing signal value at each point in the look-up table defined by the CIE x dimension, the CIE y dimension, and the luminance dimension.

20. The computer-readable medium of claim 19, wherein one of:
the look-up table further comprises a temperature dimension orthogonal to the CIE x dimension, the CIE y dimension and the luminance dimension, and the drive circuit being further adapted to access the at least one look-up table based on one of an estimated temperature and a temperature reading; and
the computer-readable medium stores at least one other look-up table, each look-up table having a corresponding temperature range and the drive circuit being further adapted to access the at least one look-up table having the corresponding temperature range that includes one of the estimated temperature and the temperature reading.

21. The computer-readable medium of claim 19, wherein the computer-readable medium is one of on a chip on which the OLED pixel is situated and on a board including a drive circuit for an array including the OLED pixel.
